(19) United States
(12) Patent Application Publication
(10) Pub. No.: US 2005/0031732 A1
(43) Pub. Date: Feb. 10, 2005

(54) Health and/or nutritional status of an aquatic animal

(75) Inventors: Peter Suhr-Jessen, Vaerlose (DK); Merete Mork Jensen, Farum (DK)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Chr. Hansen A/S

(21) Appl. No.: 10/836,598

(22) Filed: May 3, 2004

(30) Foreign Application Priority Data
May 1, 2003 (EP) 03076392.4

(51) Int. Cl. A01K 1/00

(52) U.S. Cl. 426/2

(57) ABSTRACT

An aquatic animal feed product comprising a probiotic Bacillus licheniformis bacteria and the use of this product in an aquaculture of aquatic animals in order to improve the resistance of an aquatic animal towards influential conditions in the surrounding environment, such as e.g. pathogenic micro-organisms.

### CROSS-REFERENCE TO RELATED APPLICATIONS

This application claims priority from EP03076392.4, filed May 01, 2003, the entire contents of which are incorporated herein by reference.

### FIELD OF THE INVENTION

The present invention relates to an aquatic animal feed product comprising a probiotic Bacillus licheniformis bacteria and the use of this product in an aquaculture of aquatic animals in order to improve the resistance of an aquatic animal towards influential conditions in the surrounding environment, such as. e.g., pathogenic micro-organisms.

### DESCRIPTION OF THE BACKGROUND

Aquaculture has become one of the fastest-growing food-producing sectors, and there has been much focus on the possibility of applying conventional methods known from livestock farming for disease control and growth promotion in aquaculture. However, the immediate ambient environment has a much larger influence on the health status of the marine animals than terrestrial animals. Disease outbreaks caused by the presence of harmful organisms in the surrounding environment is recognized as one of the most significant constraints on aquaculture production, affecting the economic development of the sector in many countries.

Marine animals kept in cages are vulnerable towards adverse effects from the surrounding environment. Harmful pathogenic microorganisms may proliferate in the protected aquacultural environment and cause substantial problems for the farmed animals. Even non-pathogenic microorganisms present in a large amount may constitute a potential problem in aquacultural production.

There has been much focus on controlling the presence of pathogens in the aquacultural environment by applying and testing conventional methods used in the farming of terrestrial animals. The methods include the addition of antimicrobial compounds, such as e.g. antibiotics, to the environment. However, these conventional approaches have had limited success. Furthermore, there is a general and growing concern about the use of antimicrobials, and there is a world-wide regulatory restriction on the use of antibiotics.

As expected, the need for disease control has been accounted for by the development of novel disease control methods. One such method comprises the use of “probiotics”, which are antagonistic bacterial strains to be used for the control of populations of potential pathogens through e.g. competitive exclusion. Examples of this technology are already used with the farming of terrestrial animals, where commercial probiotic products have been launched on the market. An oral administration of these products induces increased resistance to enteric infections and enhances the general immune response of the treated animal.

The prior art within aquaculture presently shows that bacterial species have been tested for control of the aquatic environment. Within aquaculture it appears from the literature, that the selected bacterial species colonize the aquatic environment including the external slime layer of fresh and salt-water aquatic animals. The effect of this bacterial colonization is the exclusion of harmful microorganisms. It has also been discovered that other natural biological processes contribute to a breakdown of organic waste into carbon dioxide and water. Importantly, it has additionally been found that the use of probiotics helps alleviate the harmful effects of e.g. transfer stress, which often accompanies the transfer of one aquatic species from one environment to another. Transfer stress is featured inter alia by the fact that the slime layers of aquatic species lose a significant portion of their natural protective microflora. It appears that exposure to large numbers of probiotic bacteria implicates the restoration of a healthy microflora. The probiotic bacteria compete with many pathogens indigenous to aquatic environments, such as e.g. Aeromonas and Vibrio species, by competitive exclusion, thereby significantly reducing the frequency of disease brought about by these bacterial pathogens.

WO02/00035 describes a bioactive food complex for controlling bacterial diseases in aquatic animals. The food complex is described as an emulsion comprising at least one probiotic bacteria, selected for antimicrobial chemical production, and at least one inhibitory or regulatory compound. The at least one inhibitory or regulatory compound is a furanone, which comprises a group of chemical compounds that inhibit surface colonisation of microorganisms in general. A generically described probiotic bacteria is Bacillus. No specific preferred Bacillus strains are mentioned and the working examples just refer to probiotic bacteria as such.

JP2000217567A describes a method to get a high concentration of spores of Bacillus bacteria, and claims the use of such Bacillus spores in fish foods. The description says that any Bacillus species may be used, and lists as examples Bacillus pumils, Bacillus lentus, Bacillus laterosporus and Bacillus alvei. All examples relate to results demonstrating improved spore formation of the described method. No concrete data is provided in relation to a possible effect when uses as fish food.

JP2000103740A describes a medicine for fish and shellfishes which contains metabolites and products as an active principle, such as a peptide obtained by the mixed culture of Bacillus thuringiensis and Bacillus pumilu. Based on specific examples it is concluded that this mixed culture improves immune system activation and prevents infection for cultured fishes.

EP287699B1 (Calpis, Japan) describes that Bacillus subtilis C-3102 has positive effects of increasing weight and improving feed efficiency, when it is given to fishes. Example 5 demonstrates increased weight gain effect for rainbow trout.

JP62138148A describes a feed additive for aquatic animals, containing microbial cells of Bacillus cereus or spores thereof as an active ingredient. It is said to have growth promoting effects on fishes and preventive effects on bacterial diseases without causing problems of pollution of fish ground, resistant germs, etc.

RU2186576 describes a method of treatment and prevention of diseases in fish, including feeding to fish a curative fodder containing a probiotic agent, characterized in that Bacillus subtilis VKPM V-4759 (in the form of spores) is used as the probiotic agent per one ton of fodder, over a period of five days.

Chr. Hansen A/S (Denmark) commercializes a product having the trade name BioPlus™2B. This product comprises a mixture of Bacillus licheniformis and Bacillus subtilis spores. In various experiments, the positive effects of the addition of BioPlus2B have been demonstrated on average daily weight gain, feed consumption, feed conversion and/or mortality in piglets and sows, and the fattening of pigs, chickens, turkeys and calves.

In relation to fish there has not been described nor suggested any effects of BioPlus2B. Presently the mode of action of BioPlus2B in above-mentioned warm-blooded animals is poorly understood. However, it is well known to the skilled person that fish is an animal that in a number of ways is very different from the above-mentioned warm-blooded animals.

### SUMMARY OF THE INVENTION

The problem to be solved by the present invention is addressed by an aquatic animal (e.g. fish) feed product capable of significantly increasing the resistance of aquacultured animal (e.g. fish) against relevant pathogenic microorganisms.

The solution is based on that the present inventors identification of a fish feed product enriched with a probiotic Bacillus licheniformis bacteria that is capable of significantly increasing the resistance of aquacultured fish against relevant pathogenic microorganisms. In working examples described herein this effect is demonstrated with BioPlus2B (comprising Bacillus licheniformis spores) enriched fish feed. It was demonstrated that such Bacillus licheniformis enriched fish feed product significantly increased the relative survival rate of aquacultured fish when challenged by exposure to Yersinia ruckeri. Yersinia ruckeri is a pathogenic microorganism that is a causative agent of enteric redmouth disease.

Accordingly, a first aspect of the invention relates to an aquatic animal feed product comprising probiotic Bacillus licheniformis bacteria.

As said above, such a feed product is highly suitable for use as a feed product for an aquatic animal.

Accordingly, a second aspect of the invention relates to a method of aquaculture of aquatic animals wherein the aquatic animals are in contact with an aquatic animal feed product comprising a probiotic Bacillus licheniformis bacteria.

In a third aspect the invention relates to a method of feeding an aquatic animal present in an aquaculture comprising feeding the aquatic animal with an aquatic animal feed product comprising probiotic Bacillus licheniformis bacteria.

Without being limited to theory, it is believed that the probiotic Bacillus licheniformis bacteria are capable of significantly increasing the amount of aquatic animal antibodies against pathogenic microorganisms such as Yersinia ruckeri. This increase in antibodies renders the aquatic animal more resistant to these pathogenic microorganisms. See working examples herein for further details. It is believed to be the first time that it is demonstrated that a probiotic organism gives its positive effect through immune stimulation rather than through competitive exclusion.

A further advantage of a feed product comprising probiotic Bacillus licheniformis bacteria is that the growth weight gain and growth length of the aquatic animal is improved. See working examples herein for further details.

### Definitions

Prior to a discussion of the detailed embodiments of the invention, a definition of specific terms related to the main aspects of the invention is provided.

The term “aquaculture” should be understood according to the art as an aquatic culture of aquatic animals wherein the animals are cultured in a physically defined space such as, e.g., in cages.

The term “probiotic” is a well-defined term in the art and relates to a microorganism that when it has been in physical contact (e.g., when eaten) with an aquatic animal it confers health benefit to the animal.

The term “Bacillus licheniformis” is a well-known and well-defined term for this Bacillus bacteria specie. For further details see, e.g., the standard reference book Bergeys Manual of Systematic Bacteriology. Based on his general knowledge, the skilled person is perfectly capable to determine whether or not a specific Bacillus bacterium of interest is a Bacillus licheniformis bacterium.

Embodiments of the present invention are described below, by way of examples only.

### DETAILED DESCRIPTION OF THE INVENTION

Aquatic Animal Feed Product

The aquatic animal feed product should comprise suitable aquatic animal feedstuff ingredients which are conventionally used in such a product. The skilled person is aware of selecting adequate ingredients in relation to the specific aquatic animal of interest. Herein, such suitable aquatic animal feedstuff ingredients may be termed conventional aquatic animal feedstuff ingredients known per se.

These ingredients should preferably be in concentrations adjusted to meet the animal's dietary requirements and may include nutrient ingredients such as animal protein products, at about 0-95 weight percent; plant protein products, at about 0-95 weight percent; poultry egg products, at about 0-25 weight percent.

Further, the aquatic animal feed product may also comprise other suitable ingredients such as Ergosan (an algine-based immunomodulator); antibiotics such as Sarafin, Romet, Terramycin at about 0.01-50 weight percent; cyanocobalamin at about 40-60 mg/kg; D-biotin at about 5-20 mg/kg; D-pantothenic acid at about 250-350 mg/kg; folic acid at about 10-30 mg/kg; L-ascorbyl-2-polyphosphate (STAY-C, stable form of vitamin C) at about 1,000-4,000 mg/kg; myo-inositol at about 3,000-4,000 mg/kg; niacin at about 600-800 mg/kg; p-amino-benzoic acid at about 350-450 mg/kg; pyridoxine hydrochloride at about 40-60 mg/kg; riboflavin at about 125-175 mg/kg; thiamine hydrochloride at about 50-80 mg/kg; and choline chloride at about 6,500 7,500 mg/kg. The aquatic animal feed product may be in any suitable form, such as a powder or in form of pellets or tablets.

The aquatic animal feed product may be in the form of, e.g., two different compositions wherein one composition comprises the suitable aquatic animal feedstuff ingredients and the other composition comprises the probiotic Bacillus bacteria as described herein. In such a case the aquatic animal feed product is comprised of such two compositions and with suitable instructions to give the compositions to the aquatic animal either simultaneously or sequentially. In other words, while the aquatic animals are fed the suitable aquatic animal feedstuff ingredients they should also be fed the probiotic Bacillus bacteria as described herein.

Alternatively, the aquatic animal feed product may be in the form of a composition comprising the suitable aquatic animal feedstuff ingredients and the probiotic Bacillus bacteria as described herein. This may, e.g., be in the form of a suitable powder or in the form of pellets or tablets.

In order to, e.g., improve some stability aspects of the probiotic bacteria it may be advantageous to provide the aquatic animal feed product as stable emulsion of solids in-oil, comprised of lipid soluble bioactive compounds such as inhibitory furanones dissolved in lipid forms of the continuous phase, with dry feed ingredients and the probiotic bacteria of interest forming the dispersed phase of the stable emulsion. See e.g. WO02/00035 for further details.

Further, the aquatic animal feed product may be in the form of a capsule, e.g., a microencapsulated product.

Probiotic Bacillus Bacteria

The probiotic Bacillus licheniformis bacteria may be any probiotic Bacillus licheniformis bacteria. Based on the information disclosed herein, the skilled person is capable of selecting a specific Bacillus licheniformis of interest.

The product BioPlus™2B (Chr. Hansen A/S, Denmark) comprises the Bacillus licheniformis DSM5749 strain. As shown in working examples herein this Bacillus licheniformis DSM5749 strain is, in the present context, highly suitable and is, therefore, a preferred Bacillus licheniformis strain. This Bacillus licheniformis DSM5749 strain may herein also be termed CH 200.

Beside the probiotic Bacillus licheniformis bacteria the aquatic animal feed product may comprise any other microorganism of interest. Preferably, it is a probiotic microorganism of interest. Preferably, such a probiotic microorganism is a Gram negative bacterium, or more preferably a Gram positive bacterium. A preferred Gram positive bacterium is a species selected from the group consisting of Lactococcus spp., Lactobacillus spp., Leuconostoc spp., Oenococcus spp., Streptococcus spp. and more preferably Bacillus spp.

Examples of preferred probiotic Bacillus species include, but are not limited to Bacillus subtilis, Bacillus laterosporus, B. azotoformans, B. circulans, B. pumilus, B. lentus, B. alvei, B. thuringiensis, B. cereus and B. firmus.

A most preferred other probiotic Bacillus specie is Bacillus subtilis. As demonstrated herein a mixture of Bacillus licheniformis and Bacillus subtilis is, in the present context, highly suitable. These two Bacillus species have different biochemical characteristic leading to a possible synergy effect.

The product BioPlus™2B (Chr. Hansen A/S, Denmark) comprises the Bacillus subtilis DSM5750 strain. As shown in working examples herein this Bacillus subtilis DSM5750 strain is, in the present context, highly suitable and is therefore a preferred Bacillus subtilis strain. This Bacillus subtilis DSM5750 strain may herein also be termed CH 201.

Accordingly, in a preferred embodiment the aquatic animal feed product comprises a mixture of probiotic Bacillus licheniformis bacteria and probiotic Bacillus subtilis bacteria.

Preferably, the aquatic animal feed product comprises the probiotic Bacillus licheniformis bacteria in a concentration of at least about 1×10⁶ CFU/g feed, such as 1×10⁶ CFU/g feed, more preferably in a concentration of at least about 1×10⁷ CFU/g feed, such as 1×10⁷ CFU/g feed, even more preferably in a concentration of at least 1×10⁸ CFU/g feed, such as 1×10⁸ CFU/g feed. Generally, the aquatic animal feed product comprises the probiotic Bacillus licheniformis bacteria in a concentration of less than about 1×10¹⁴ CFU/g feed, such as 1×10¹⁴ CFU/g feed.

When the aquatic animal feed product comprises a mixture of the probiotic Bacillus licheniformis bacteria and one or more another probiotic microorganisms (such as Bacillus subtilis) it is preferred that there are, based on total amount of probiotic microorganisms, from 5 to 95% of the probiotic Bacillus licheniformis bacteria and from 5 to 95% of the other probiotic microorganism. The skilled person does, of course, understand that the total probiotic microorganism content cannot exceed 100%. In other words, if 80% is Bacillus licheniformis then the other microorganisms cannot exceed 20%.

When another probiotic microorganism is Bacillus subtilis, it is preferred that there are, based on total amount of probiotic microorganisms, from 35 to 65% of the probiotic Bacillus licheniformis bacteria and from 35 to 65% of the Bacillus subtilis bacteria (based on total amount of probiotic microorganisms).

The probiotic Bacillus bacteria may e.g. be in the form of bacterial spores, vegetative bacterial cells, bacterial cell walls or any combination thereof. Preferably probiotic Bacillus bacteria are in the form of vegetative bacterial cells or more preferably in the form of bacterial spores.

Preferably, the probiotic Bacillus bacteria are included in the aquatic animal feed product as dried (preferably freeze-dried) bacteria. However, they may also be included as a frozen culture of bacteria.

Aquatic Animal

It is appreciated that the aquatic animal feed product as described herein is particularly useful within the fishing and aquaculture industries, primarily by causing a reduction in the harmful effects of microbial organisms exerted on shellfish, cartilaginous fish, fin fish or aquatic mammals.

Shellfish may comprise the group of filter-feeding bivalves such as e.g. clams, oysters, scallops and mussels, and may in addition comprise lobsters, crabs and shrimps.

Finfish include, but are not limited to the salmonid species including Atlantic salmon (Salmo salar), rainbow trout (Oncorhynchus mykiss).

Further preferred aquatic animal is a fish including a gadid species including Gadus callarias, sea trout (Salmo trutta) and sea bass (Dicentrarchus labrax) and cod, eel as well as fresh water finfish and carp. Further, an aquatic animal may be a dolphin or a whale.

Aquatic animals further encompass any of the broadly known ornamental fish widely used throughout the hobby of fish tank maintenance. Ornamental hobby fish include both fresh water and salt water fish. Representative species of ornamental fish are well known to enthusiasts of the hobby.

Preferably the aquatic animal is an animal farmed in an aquaculture. The aquatic animal may be in an early developmental stage e.g., such as larvae and juvenile animals, or a later developmental stage subsequent to the juvenile stage.

Resistance Against Pathogenic Microorganisms

As said above the aquatic animal feed product, as described herein, is capable of significantly increasing the resistance of aquacultured animals against relevant pathogenic microorganisms. In working examples herein, this is demonstrated for BioPlus2B (comprising Bacillus licheniformis spores) enriched fish feed. It was demonstrated that such Bacillus licheniformis enriched fish feed product significantly increased the relative survival rate of aquacultured fish when challenged by exposure to Yersinia ruckeri. Yersinia ruckeri is an important pathogenic microorganism that is a causative agent for enteric redmouth disease.

In working examples herein, it is shown that for aquacultured rainbow trout fed an aquatic animal feed product, increased the relative survival rate of the rainbow trout against Yersinia ruckeri by at least 20% as compared to a control group fed with the corresponding animal feed product without the probiotic Bacillus bacteria.

In the present context, the fish rainbow trout is believed to be a representative aquatic animal. In other words, when the positive resistance effect against Yersinia ruckeri has been demonstrated for rainbow trout it also applies to other aquatic animals in general. Without being limited to theory, it is presently believed to be the first time that it has been demonstrated that a probiotic microorganism may give such a positive effect against an important pathogenic microorganism such as Yersinia ruckeri.

Accordingly, a preferred embodiment relates to an aquatic animal feed product, as described herein, characterized by that when it is used for feeding an aquaculture of rainbow trout, the aquatic animal feed product is capable of providing an at least 2% increase in relative survival rate of the rainbow trout as compared to a control group fed with the corresponding animal feed product without the probiotic Bacillus licheniformis bacteria when the rainbow trout were challenged with Yersinia ruckeri.

As said above, in a preferred embodiment the aquatic animal feed product comprises both probiotic Bacillus licheniformis bacteria and probiotic Bacillus subtilis bacteria, since these two Bacillus species have different biochemical characteristic leading to a possible synergistic effect. In this special situation in relation to this specific embodiment the corresponding animal feed control product should preferably be without probiotic Bacillus licheniformis bacteria and probiotic Bacillus subtilis bacteria, but may optionally contain probiotic Bacillus subtilis bacteria.

In working examples herein, is provided a suitable test assay to evaluate the increased resistance of rainbow trout against challenge with Yersinia ruckeri. In the present context this is a preferred assay. Based on the relevant information of the working examples, the skilled person may, based on his general knowledge, make a corresponding assay that would be sufficiently accurate to, within normal measurement uncertainty, determine the increase in relative survival rate of the rainbow trout.

In short, this assay comprises the steps of:
(i) making two populations of an aquaculture of rainbow trout consisting of 100 4 month old fish
(ii) feeding one population, in an 1 m×1 m×1 m aquarium, with the aquatic animal feed product as described herein (28 days with a daily dose of three percent of their biomass) and feeding the other population similarly but using a corresponding animal feed control product without the probiotic Bacillus licheniformis bacteria (control group)
(iii) after the 28 days of feeding, transporting 10 fish of each group over to new aquariums
(iv) after two days of acclimatization, challenging the fish with Yersinia ruckeri by intra peritoneal injection of a dose of about 2.5×10⁶ CFU per fish, such as 2.5×10⁶ CFU per fish
(v) observing the fish during a period of 28 days in separate aquariums (12-13° C.) and calculating daily the mortality and relative percent survival.

Preferably the aquatic animal feed product, as described herein, is characterized by that when it is used for feeding an aquaculture of rainbow trout it is capable of providing an at least 5% (more preferably at least 10%, even more preferably at least 15%) increase in relative survival rate of the rainbow trout as compared to a control group fed the corresponding animal feed product lacking probiotic Bacillus licheniformis bacteria, when the rainbow trout were challenged with Yersinia ruckeri.

An Aquaculture of Aquatic Animals Wherein the Aquatic Animals Are in Contact with the Aquatic Animal Feed Product as Described Herein

Preferably this relates to an industrially relevant aquaculture wherein the aquatic animals are cultured in a physically defined space of at least 1 m×1 m×1 m such as e.g. in an aquarium of at least 1 m×1 m×1 m. The physically defined space of the aquaculture may be significantly bigger such as, e.g. 10 m×10 m×5 m.

The term “the aquatic animals are in contact with the aquatic animal feed product” denotes a typical situation just after introduction of the feed product where the aquatic animals are in contact with the aquatic animal feed product, for instance while they are eating the feed product.

Feeding may be done according to techniques known in the art, and the skilled person is aware of how to properly feed aquatic animals present in an aquaculture system.

In a preferred embodiment the aquatic animals of the aquaculture are in contact with an amount of aquatic animal feed product that corresponds to from about 0.5% to about 25%, for example from 0.5% to 25%, of the total biomass of the aquatic animals of the aquaculture, more preferably the aquatic animals of the aquaculture are in contact with an amount of aquatic animal feed product that corresponds to from about 1% to about 10%, for example from 1% to 10%, of the total biomass of the aquatic animals of the aquaculture.

A Method for Feeding an Aquatic Animal Present in an Aquaculture Comprising Feeding the Aquatic Animal with an Aquatic Animal Feed Product as Described Herein

As said above feeding may be done according to techniques known in the art and the skilled person is aware of how to properly feed aquatic animals present in an aquaculture system.

Preferably, the aquatic animals of the aquaculture are feed with an amount of aquatic animal feed product that corresponds to from about 0.5% to about 25%, for example from 0.5% to 25%, of the total biomass of the aquatic animals of the aquaculture, more preferably with an amount of aquatic animal feed product that corresponds to from about 1% to about 10%, for example from 1% to 10%, of the total biomass of the aquatic animals of the aquaculture. Preferably, the aquatic animals are fed a daily dose of the aquatic animal feed product.

As illustrated in, e.g., working examples herein the aquatic animal feed product, as described herein, also improves the weight gain and/or feed conversion for aquatic animals.

Accordingly, a preferred embodiment relates to a method for feeding an aquatic animal present in an aquaculture comprising feeding the aquatic animal with an aquatic animal feed product, as described herein, wherein the weight gain is at least about 2%, for example 2%, such as at least about 5%, 7%, 10%, 15%, 30%, 40%, 50%, for example at least 5%, 7%, 10%, 15%, 30%, 40%, 50%, or even more as compared to a control group fed the corresponding animal feed product lacking probiotic Bacillus licheniformis bacteria.

Further, a preferred embodiment relates to a method for feeding an aquatic animal present in an aquaculture comprising feeding the aquatic animal with an aquatic animal feed product, as described herein, wherein feed conversion is increased by at least about 2%, for example 2%, such as at least about 4%, 7%, 10%, 15%, 20%, 30%, for example at least 4%, 7%, 10%, 15%, 20%, 30%, or even more as compared to a control group fed the corresponding animal feed product lacking probiotic Bacillus licheniformis bacteria.

Even further, a preferred embodiment relates to a method for feeding an aquatic animal present in an aquaculture comprising feeding the aquatic animal with an aquatic animal feed product, as described herein, wherein there is obtained an at least about 2%, for example at least 2%, increase in relative survival rate of the aquatic animal as compared to a control group fed the corresponding animal feed product lacking probiotic Bacillus licheniformis bacteria, when the aquatic animal is challenged with Yersinia ruckeri.

As said above, in a preferred embodiment the aquatic animal feed product comprises both probiotic Bacillus licheniformis bacteria and probiotic Bacillus subtilis bacteria, since these two Bacillus species have different biochemical characteristic leading to a possible synergistic effect. In this special situation in relation to this specific embodiment the corresponding animal feed control product should be without both the probiotic Bacillus licheniformis bacteria and the probiotic Bacillus subtilis bacteria.

As explained in section “Resistance against pathogenic microorganisms” above, in working examples herein is provided a suitable test assay to evaluate the increased resistance against challenge with Yersinia ruckeri. The above-referenced text focused on assaying rainbow trout. However, it will be understood that the above-referenced assay is non-limiting, and that a corresponding assay for any aquatic animal of interest that would be sufficiently accurate to, within normal measurement uncertainty, determine the increase in relative survival rate of the aquatic animal of interest.

Preferably, in the method for feeding an aquatic animal, as described herein, there is obtained an at least about 5%, for example at least 5% (more preferably at least about 10%, for example at least 10%, even more preferably at least about 15%, for example at least 15%) increase in relative survival rate of the aquatic animal as compared to a control group fed the corresponding animal feed product without the probiotic Bacillus licheniformis bacteria when the aquatic animal is challenged with Yersinia ruckeri.

A Separate Aspect of the Invention

As said above it is presently believed to be the first time that it has been demonstrated that a probiotic microorganism may give the herein described positive effect against an important pathogenic microorganism such as Yersinia ruckeri.

Without being limited to theory, it is believed that based on the information provided herein the skilled person is able to, based on his common general knowledge, identify other probiotic microorganisms and combinations of these that also could give this positive effect.

Accordingly, a separate aspect of the invention relates to a method for feeding an aquatic animal present in an aquaculture comprising feeding the aquatic animal with an aquatic animal feed product comprising a probiotic microorganism wherein there is obtained an at least about 2%, for example at least 2%, increase in relative survival rate of the aquatic animal as compared to a control group fed the corresponding animal feed product lacking probiotic microorganism, when the aquatic animal is challenged with Yersinia ruckeri.

Preferably, the probiotic microorganism is a Gram negative bacterium or more preferably a Gram positive bacterium. A preferred Gram positive bacterium is a species selected from the group consisting of Lactococcus spp., Lactobacillus spp., Leuconostoc spp., Oenococcus spp., Streptococcus spp. and more preferably Bacillus spp.

All other aspects, embodiments and other information herein are also relevant and included in relation to this separate aspect of the invention.

### EXAMPLES

Material and Methods

Fish

Rainbow trout was obtained by hatching out eggs provided to Borhholms Lakseklækkeri, Denmark from Faarup Mølle Dambrug, Denmark. The eggs were sterilized at arrival and were hatched out in re-circulated fresh water at 7° C.

Rainbow trout fish fry were hatched out the 1 of Marts 2002 and were thereafter kept in 10° C. cold water in special trays and after that kept in aquariums of 1 m×1 m×1 m. Trout were fed commercial rainbow trout feed (BioMar, Denmark) until they were used in the experiments.

The Aquaculture Site

The aquaculture site was at Borhholms Lakseklækkeri, Denmark. The water at the site was re-circulated fresh water and was continuously kept free of pathogens. The water was circulated by mechanical and biologic filtration and UV-treatment.

Experimental Design

4 month old rainbow trout fish were placed in 6 groups each of 100 individual fish. They were cultured in aquariums of 1 m×1 m×1 m in re-circulated water at 10° C.

Two groups were control groups that were fed BioMar rainbow trout feed without addition of probiotic.

Two groups were fed the same feed enriched with the algine-based immunomodulator product Aquavac Ergosan (Aquaculture Vaccines Ltd.). It was added to 0.2% in mixed feed according to manufacturer's instructions.

Two groups were fed the same feed enriched with probiotic Bacillus bacteria. The food was enriched with BioPlus2B (Chr. Hansen A/S). The quantitative composition of BioPlus 2B was as follows:

| | |
|---|---|
| Bacillus licheniformis CH 200 spore concentrate | 0.5% |
| Bacillus subtilis CH 201 spore concentrate | 0.5% |
| Sodium alumino silicate (E 554) | 1.0% |
| Whey permeate | 98.0% |

BioPlus2B was added to get a Bacillus concentration of 4×10⁹ CFU/g feed.

All fish were given a daily feed portion that corresponded to 3% of their total biomass. The experiment was started the 2 Jul. 2002 and finished 13 Aug. 2002. Samples were taken out and analyzed 2 Jul. 2002, 16 Jul. 2002, 30 Jul. 2002 and 13 Aug. 2002.

Samples Analyses

Blood

At each sample analysis a blood sample of 10 fish was taken from each group with the exception of the first sample outtake of naive fish, where there were taken blood samples from 20 fish in total. The blood sample test was performed in heparinsed heamatocrit tubes (10 or 20 microliter volume). The heamatocrit analysis was done after 5 minutes centrifugation at 1000×g. After that the tubes were cut, volume calculated and the plasma sample was kept at −20° C. until further analysis. Further, a blood cell plating was done on object glasses, which were air dried and thereafter fixed in absolute ethanol. The cells were colored with Giemsa and the number of lymphocytes per 1000 blood cells was counted by microscope. The plasma sample was also used for protein detection, where a BCA-kit (Pierce) was used.

Challenge

At each day where samples were taken out there were collected 10 fish from each group. These fish were transported alive to other aquariums. After a 2 day acclimation period the fish where exposed to Yersinia ruckeri by intra peritoneal injection of a dose of about 2.5×10⁶ CFU per fish. In separate aquariums (12-13° C.), the fishes were continuously observed for a period of 28 days thereafter. The mortality was daily registered and the relative percent survival was calculated.

Antibody Determination

In order to determine if there were different antibody profiles against Yersinia ruckeri in the different groups of rainbow trout samples the plasma samples were also used in an ELISA test. Microtiter plates (96 wells immunoplates) were coated with formalin killed Yersinia ruckeri (200 microliter per well, 1×10⁵ cfu/ml) at standard conditions. The assay was done by standard methods of blocking and washing. Plasma from the test sample fishes (diluted 1:100) was used as primary antibody, rabbit antibody that reacted with the rainbow trout antibody was used as secondary antibody and as tertiary antibody a peroxidase conjugated goat antibody (Sigma) was used. Chromogenic substrate was OPD (Sigma) and the absorbance was measured at 492 nm.

Bacillus Spores in Feed and Fish Intestinal Tract

At day 42 samples were taken from the different test groups in order to analyze for the presence of Bacillus subtilis and Bacillus licheniformis in the intestinal tract of the fishes. Further there were taken samples of the used BioMar feed.

Length and Weight Gain

At each day and time where fish samples were taken out the length and the weight of the fished were determined.

Results

General

There were no registered incidents of anorexia or other adverse effects in any of the test groups. The rainbow trouts ate all the feed in a satisfactory manner.

Challenge

In the Yersinia ruckeri challenge experiments, the Ergosan group did not have any improved survival rate in relation to the control group after 14 and 28 days. A weak limited improved survival rate was seen after 42 days of feeding with the Ergosan enriched feed.

Fishes that were fed BioPlus2B enriched feed had a significantly improved survival rate at all tests. The relative survival rate was 20%, 20%, and 35% after respectively 14, 28 and 42 days feeding with the BioPlus2B enriched feed.

Blood Parameters

In relation to plasma protein, haematocrit values and lymphocyte cell numbers it was not possible to identify significant measurable differences between the individual test groups. However, in relation to antibody profiles against Yersinia ruckeri it was clearly seen that there was a significantly higher Yersinia ruckeri antibody titer in the BioPlus2B enriched feed group as compared to the Ergosan enriched feed group.

Bacillus Spores in Feed and Fish Intestinal Tract

Analyses demonstrated a high concentration of the two Bacillus species in the fishes fed BioPlus2B enriched feed plus in the BioPlus2B enriched feed as such.

Length and Weight Gain

Both the length and weight gain was significantly increased in the BioPlus2B group as compared to both the control and Ergosan group.

Discussion

This investigation demonstrated that BioPlus2B enriched fish feed product could significantly increase the relative survival rate of aqua-cultured rainbow trout fish when challenging the aqua-cultured fish by exposure to the pathogen Yersinia ruckeri.

Results demonstrated that there was a significantly higher Yersinia ruckeri antibody titer in the BioPlus2B enriched feed group as compared to the Ergosan enriched feed group. It is believed this increase in antibodies then makes the rainbow trout more resistant to the pathogen Yersinia ruckeri.

Further, both the length and weight gain was significantly increased in the BioPlus2B group as compared to both the control and Ergosan group.

### REFERENCES

WO 02/00035
JP 2000217567A
JP 2000103740A
EP 287699B1 (Calpis, Japan)
JP 62138148 A
RU 2186576
BioPlus™2B (Chr. Hansen A/S, Denmark)

1. An aquatic animal feed product comprising a probiotic Bacillus licheniformis bacteria.

2. The aquatic animal feed product of claim 1, wherein the aquatic animal feed product comprises the probiotic Bacillus licheniformis bacteria in a concentration of at least 1×10⁶ CFU/g feed.

3. The aquatic animal feed product of claim 1, wherein the product comprises a mixture of probiotic Bacillus licheniformis bacteria and probiotic Bacillus subtilis bacteria.

4. The aquatic animal feed product of claim 1, which, when used for feeding an aquaculture of rainbow trout, the aquatic animal feed product is capable of providing at least about a 2% increase in relative survival rate of the rainbow trout as compared to a control group fed the equivalent animal feed product lacking probiotic Bacillus licheniformis bacteria, when the rainbow trout are challenged with pathogenic Yersinia ruckeri.

5. A method of performing aquaculture of aquatic animals wherein the aquatic animals are in contact with an aquatic animal feed product comprising a probiotic Bacillus licheniformis bacteria of claim 1.

6. The method of claim 5, wherein the aquatic animals are in contact with an amount of aquatic animal feed product that corresponds to from about 0.5% to about 10% of the total biomass of the aquatic animals of the aquaculture.

7. The method of claim 5, wherein the aquatic animals are finfish.

8. The method of claim 7, wherein the finfish include salmonid species including Atlantic salmon (Salmo salar) and rainbow trout (Oncorhynchus mykiss).

9. A method for feeding an aquatic animal present in an aquaculture comprising feeding the aquatic animal with an aquatic animal feed product comprising a probiotic Bacillus licheniformis bacteria of claim 1.

10. The method of claim 9, wherein the aquatic animal is a finfish.

11. The method of claim 10, wherein the finfish include salmonid species including Atlantic salmon (Salmo salar) and rainbow trout (Oncorhynchus mykiss).

12. The method of claim 3, wherein the Bacillus licheniformis is present in a concentration of from about 35% to about 65%, and the Bacillus subtilis is present in a concentration of from about 35% to about 65%, wherein the combination of the concentrations of the two probiotic microorganisms equals 100%

13. The method of claims 5 or 9, wherein the aquatic animal is an ornamental fish.
